(19) United States
(12) Patent Application Publication
(10) Pub. No.: US 2025/0343947 A1
(43) Pub. Date: Nov. 6, 2025

(54) FRAMEWORKS FOR IMPLEMENTING STREAMABLE AND HARDWARE ACCELERATED NEURAL 3D VOLUMES

(71) Applicant: NVIDIA CORPORATION, Santa Clara, CA (US)

(72) Inventors: Michael STENGEL, San Jose, CA (US); Amrita MAZUMDAR, San Francisco, CA (US); Koki NAGANO, Playa Vista, CA (US); Matthew CHAN, Los Altos, CA (US); Shalini DE MELLO, San Francisco, CA (US); Alex EVANS, London (GB); David LUEBKE, Charlottesville, VA (US)

(21) Appl. No.: 19/194,579

(22) Filed: Apr. 30, 2025

Related U.S. Application Data
(60) Provisional application No. 63/641,368, filed on May 1, 2024.

(51) Int. Cl. H04N 19/597; G06T 15/00

(52) U.S. Cl. CPC H04N 19/597; G06T 15/00

(57) ABSTRACT

At least one embodiment is directed towards a computer-implemented method for generating compressed video content. The computer-implemented method includes the steps of receiving a plurality of triplanes associated with video content; extracting channel range values from each triplane included in the plurality of triplanes; normalizing the plurality of triplanes based on the channel range values to generate a plurality of normalized triplanes; storing the channel range values with the plurality of normalized triplanes; generating a plurality of tiled triplanes based on the plurality of normalized triplanes; compressing the plurality of tiled triplanes to generate compressed video content; and transmitting the compressed video content to an endpoint device. Another embodiment is directed towards a computer-method for rendering video content. Yet another embodiment is directed towards a computer-implemented method for training generative artificial intelligence (AI) models.

### CROSS-REFERENCE TO RELATED APPLICATIONS

The present application claims the benefit of U.S. Provisional application titled, “TECHNIQUES FOR STREAMABLE AND HARDWARE-ACCELERATED NEURAL 3D VOLUMES,” filed on May 1, 2024, and having Ser. No. 63/641,368. The subject matter of this related application is hereby incorporated herein by reference.

### BACKGROUND

### Field of the Various Embodiments

The various embodiments relate generally to computer science, video streaming, and computer vision and, more specifically, to frameworks for implementing streamable and hardware accelerated neural 3D volumes.

### Description of the Related Art

Video conferencing applications primarily stream 2D videos using monocular 2D video cameras, distributing video to clients via a client-server architecture that does not require specialized hardware. Recent technological advancements have enabled the use of 3D video in video conferencing applications instead. This work has revealed that video conferencing in 3D can provide a more natural conversational experience by providing higher immersion through features like eye contact, which can also help reduce fatigue.

One drawback of existing 3D video conferencing tools is the requirement of specialized hardware. In particular, to capture a 3D image of a conferencing subject, the subject must sit in a specialized rig with many cameras that simultaneously capture an image of the subject from multiple angles. Alternative approaches can make use of fewer cameras at conference time, provided the subject has a template captured in a multi-camera system as a preparatory step. These expensive multi-camera systems are impractical for most video conferencing environments and present a high upfront cost for participation.

Another drawback of existing 3D video conferencing tools is that such tools require significant network latency and overhead. In particular, the 3D models generated by 3D video conferencing tools are very large relative to the corresponding 2D videos. As a result, transmitting the 3D models over the network to the server and client systems can put substantial load on the network. Additionally, such significant network overhead can lead to latency issues, and even small delays in back-and-forth video conferencing can make the entire system impractical. Therefore, existing 3D video conferencing systems require not only investments in specialized hardware, but investments in network infrastructure as well.

As the foregoing illustrates, what is needed in the art are more effective approaches for implementing 3D video conferencing systems.

### SUMMARY

One embodiment sets forth a computer-implemented method for generating compressed video content. According to some embodiments, the method includes the steps of receiving a plurality of triplanes associated with video content; extracting channel range values from each triplane included in the plurality of triplanes; normalizing the plurality of triplanes based on the channel range values to generate a plurality of normalized triplanes; storing the channel range values with the plurality of normalized triplanes; generating a plurality of tiled triplanes based on the plurality of normalized triplanes; compressing the plurality of tiled triplanes to generate compressed video content; and transmitting the compressed video content to an endpoint device.

Another embodiment sets forth a computer-implemented method for rendering video content. According to some embodiments, the method includes the steps of decompressing compressed video content to generate decompressed video content, where the decompressed video content includes a plurality of normalized triplanes; de-normalizing the plurality of normalized triplanes to generate a plurality of modified triplanes; performing neural rendering operations to generate a plurality of final images via ray tracing based on the plurality of modified triplanes; and displaying the plurality of final images as rendered video content via a display device.

Yet another embodiment sets for a computer-implemented method for training generative artificial intelligence (AI) models. According to some embodiments, the method includes the steps of receiving a plurality of training images; rendering, via a generative AI model, a plurality of synthetic images based on the plurality of training images; generating triplane loss metrics for the plurality of synthetic images by comparing the plurality of synthetic images against the plurality of training images; generating total variation (TV) loss metrics based on the triplane loss metrics; generating triplane compression loss metrics based on the triplane loss metrics; generating total loss metrics based on the TV loss metrics and the triplane compression loss metrics; and performing at least one backpropagation operation based on the total loss metrics to update weights associated with the generative AI model to generate an updated generative AI model.

One technical advantage of the disclosed techniques relative to the prior art is that the disclosed techniques do not require specialized camera hardware or pre-video imaging to generate high-fidelity 3D images. As a result, the disclosed techniques can be used to implement video conferencing applications using existing hardware without additional implementation or equipment costs. An additional technical advantage of the disclosed techniques relative to the prior art is that the disclosed techniques provide for significantly reduced network and rendering overhead. In particular, by leveraging video compression tools, the disclosed techniques are capable of transmitting 3D video with sufficient speed to enable live video conferencing. Additionally, efficient improvements on the rendering side similarly enable live video conferencing with neural rendered 3D images.

These technical advantages provide one or more technological advances over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of various embodiments.

FIG. 2 is a block diagram illustrating the machine learning server of FIG. 1 in greater detail, according to various embodiments.

FIG. 3 is a block diagram illustrating the computing device of FIG. 1 in greater detail, according to various embodiments.

FIG. 4 is a more detailed illustration of the 3D streaming module of FIG. 1, according to various embodiments.

FIG. 5 is a more detailed illustration of the triplane compressor of FIG. 4, according to various embodiments.

FIG. 6 sets forth a flow diagram of method steps for generating compressed tiled triplanes, according to various embodiments.

FIG. 7 is a more detailed illustration of the neural rendering module of FIG. 4, according to various embodiments.

FIG. 8 sets forth a flow diagram of method steps for efficient neural rendering of 3D images from compressed tiled triplanes, according to various embodiments.

FIG. 9 is a more detailed illustration of model trainer of FIG. 1, according to various embodiments.

FIG. 10 sets forth a flow diagram of method steps for training a triplane model suitable for generating compressible triplanes, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

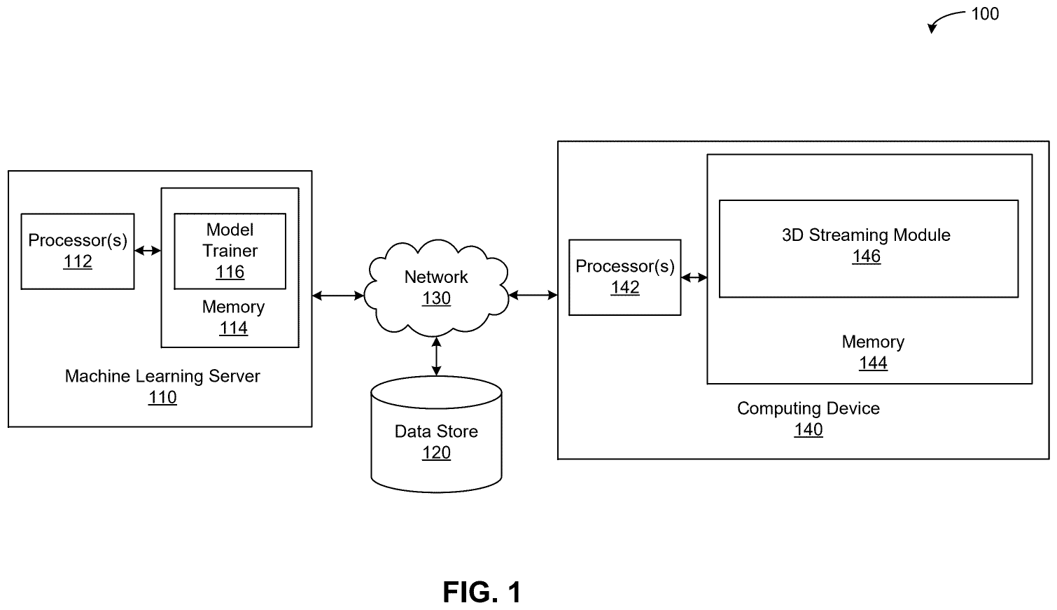

FIG. 1 illustrates a block diagram of a computer-based system 100 configured to implement one or more aspects of the various embodiments. As shown, the system 100 includes, without limitation, a machine learning server 110, a data store 120, and a computing device 140 in communication over a network 130, which can be a wide area network (WAN) such as the internet, a local area network (LAN), a cellular network, and/or any other suitable network.

As also shown, a model trainer 116 executes on one or more processors 112 of the machine learning server 110 and is stored in a system memory 114 of the machine learning server 110. The one or more processors 112 receive user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a secure digital card, an external flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

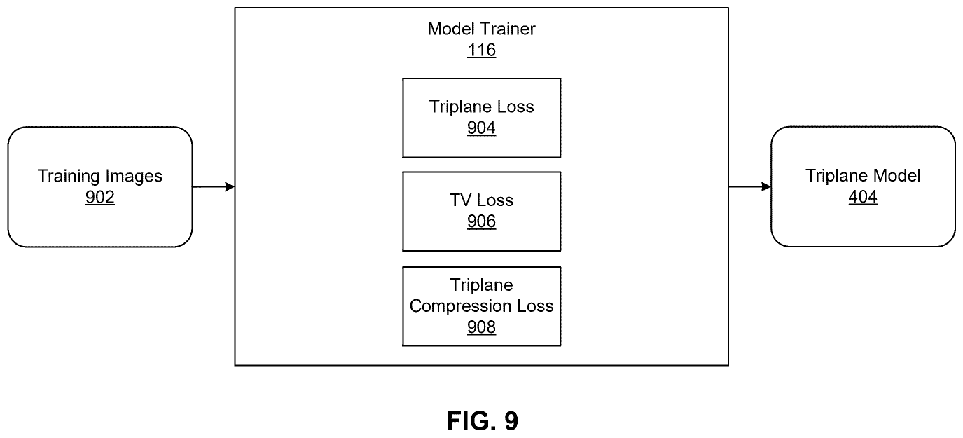

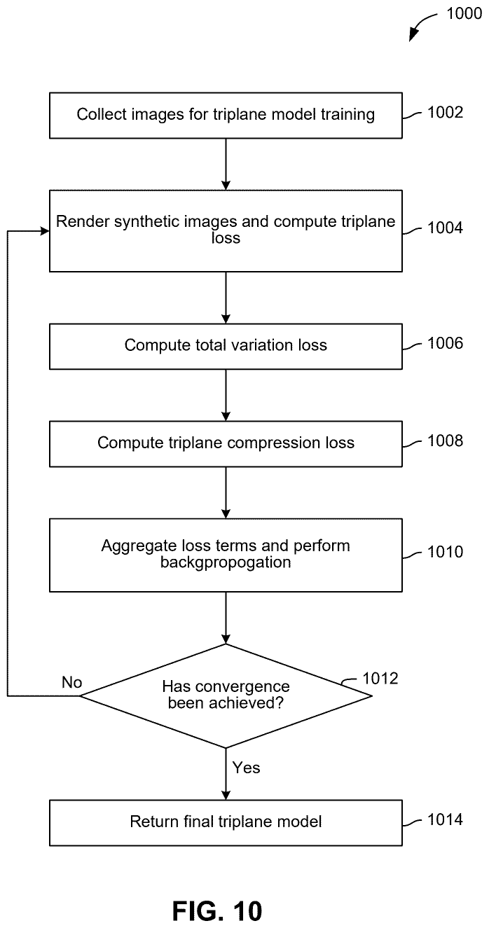

In some embodiments, the model trainer 116 is configured to train one or more machine learning models, including 3D streaming module 146. Techniques that the model trainer 116 can use to train the machine learning model(s) are discussed in greater detail below in conjunction with FIGS. 9-10. Training data and/or trained (or deployed) machine learning models, including 3D streaming module 146, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment, the machine learning server 110 can include the data store 120.

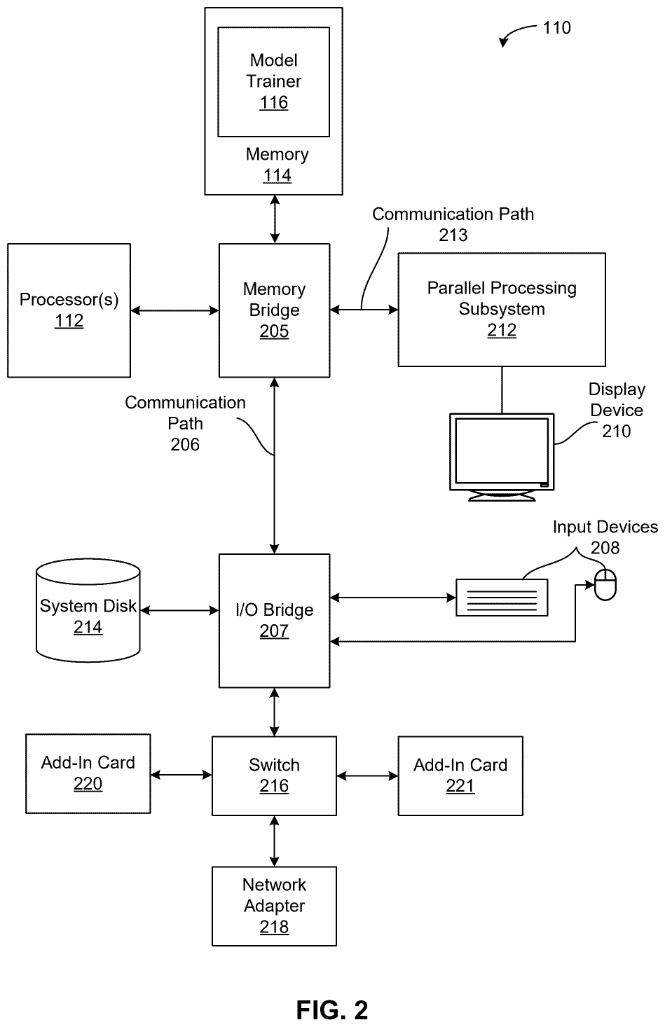

FIG. 2 is a block diagram illustrating the machine learning server 110 of FIG. 1 in greater detail, according to various embodiments. Machine learning server 110 may be any type of computing system, including, without limitation, a server machine, a server platform, a desktop machine, a laptop machine, a hand-held/mobile device, a digital kiosk, or a wearable device. In some embodiments, machine learning server 110 is a server machine operating in a data center or a cloud computing environment that provides scalable computing resources as a service over a network.

In various embodiments, machine learning server 110 includes, without limitation, the processor(s) 112 and the memory (IES) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., Evaluating gestures, speech, or other information about one or more uses in a field of view or sensory field of one or more sensors), and/or the like, and forward the input information to the processor(s) 112 for processing. In some embodiments, machine learning server 110 may be a server machine in a cloud computing environment. In such embodiments, machine learning server 110 may not include input devices 208 but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add-in cards 220 and 221.

In some embodiments, I/O bridge 207 is coupled to a system disk 214 that may be configured to store content and applications and data for use by processor(s) 112 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-rom), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a northbridge chip, and I/O bridge 207 may be a southbridge chip. In addition, communication paths 206 and 213, as well as other communication paths within machine learning server 110, may be implemented using any technically suitable protocols, including, without limitation, AGP (accelerated graphics port), hypertransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212. In various embodiments, the parallel processing subsystem 212 incorporates circuitry optimized (e.g., That undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations.

In various embodiments, parallel processing subsystem 212 may be integrated with one or more of the other elements of FIG. 2 to form a single system. For example, parallel processing subsystem 212 may be integrated with processor 112 and other connection circuitry on a single chip to form a system on a chip (soc).

System memory 114 includes at least one device driver configured to manage the processing operations of the one or more PPUs within parallel processing subsystem 212. In addition, the system memory 114 includes the model trainer 116. Although described herein primarily with respect to the model trainer 116, techniques disclosed herein can also be implemented, either entirely or in part, in other software and/or hardware, such as in the parallel processing subsystem 212.

In some embodiments, processor(s) 112 includes the primary processor of machine learning server 110, controlling and coordinating operations of other system components. In some embodiments, the processor(s) 112 issues commands that control the operation of PPUs. In some embodiments, communication path 213 is a PCI express link, in which dedicated lanes are allocated to each PPU. Other communication paths may also be used. The PPU advantageously implements a highly parallel processing architecture, and the PPU may be provided with any amount of local parallel processing memory.

It will be appreciated that the system shown herein is illustrative and that variations and modifications are possible. The connection topology, including the number and arrangement of bridges or the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (VPU(s)) that renders graphics on a virtual machine(s) (VM(s)) executing on a server machine(s) whose GPU(s) and other physical resources are shared across one or more VMs.

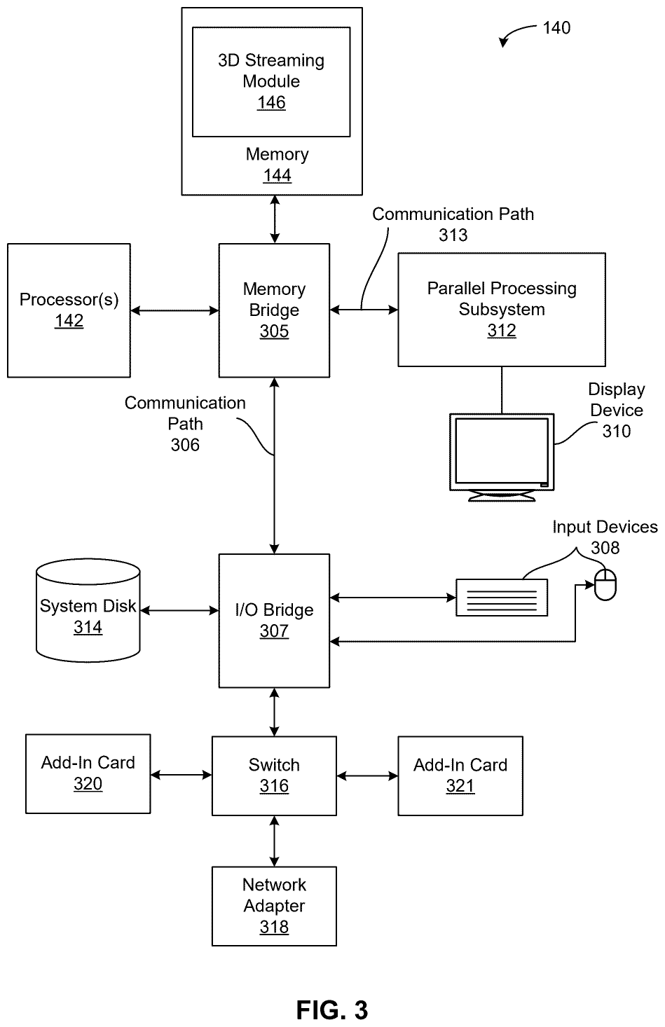

FIG. 3 is a block diagram illustrating the computing device 140 of FIG. 1 in greater detail, according to various embodiments. Computing device 140 may be any type of computing system, including, without limitation, a server machine, a server platform, a desktop machine, a laptop machine, a hand-held/mobile device, a digital kiosk, or a wearable device. In some embodiments, computing device 140 is a server machine operating in a data center or a cloud computing environment that provides scalable computing resources as a service over a network.

In various embodiments, the computing device 140 includes, without limitation, the processor(s) 142 and the memory (IES) 144 coupled to a parallel processing subsystem 312 via a memory bridge 305 and a communication path 313. Memory bridge 305 is further coupled to an I/O (input/output) bridge 307 via a communication path 306, and I/O bridge 307 is, in turn, coupled to a switch 316.

In one embodiment, I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing device 140 may be a server machine in a cloud computing environment. In such embodiments, computing device 140 may not include input devices 308, but may receive equivalent input information by receiving commands (e.g., Responsive to one or more inputs from a remote computing device) in the form of messages transmitted over a network and received via the network adapter 318. In some embodiments, switch 316 is configured to provide connections between I/O bridge 307 and other components of the 3D streaming module 146, such as a network adapter 318 and various add-in cards 320 and 321.

In some embodiments, I/O bridge 307 is coupled to a system disk 314 that may be configured to store content and applications and data for use by processor(s) 142 and parallel processing subsystem 312. In one embodiment, system disk 314 provides non-volatile storage for applications and data and may include fixed or removable hard disk drives, flash memory devices, and CD-ROM (compact disc read-only-memory), DVD-ROM (digital versatile disc-rom), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 307 as well.

In various embodiments, memory bridge 305 may be a northbridge chip, and I/O bridge 307 may be a southbridge chip. In addition, communication paths 306 and 313, as well as other communication paths within 3D streaming module 146, may be implemented using any technically suitable protocols, including, without limitation, AGP (accelerated graphics port), hypertransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312. In various embodiments, the parallel processing subsystem 312 incorporates circuitry optimized (e.g., That undergoes optimization) for general purpose and/or compute processing. Again, such circuitry may be incorporated across one or more PPUs included within parallel processing subsystem 312 that are configured to perform such general purpose and/or compute operations. In yet other embodiments, the one or more PPUs included within parallel processing subsystem 312 may be configured to perform graphics processing, general purpose processing, and/or compute processing operations.

In various embodiments, parallel processing subsystem 312 may be integrated with one or more of the other elements of FIG. 3 to form a single system. For example, parallel processing subsystem 312 may be integrated with processor 142 and other connection circuitry on a single chip to form a system on a chip (soc).

System memory 144 includes at least one device driver configured to manage the processing operations of the one or more PPUs within parallel processing subsystem 312. In addition, the system memory 144 includes the model trainer 116. Although described herein primarily with respect to the model trainer 116, techniques disclosed herein can also be implemented, either entirely or in part, in other software and/or hardware, such as in the parallel processing subsystem 312.

In some embodiments, processor(s) 142 includes the primary processor of 3D streaming module 146, controlling and coordinating operations of other system components. In some embodiments, the processor(s) 142 issues commands that control the operation of PPUs. In some embodiments, communication path 313 is a PCI express link, in which dedicated lanes are allocated to each PPU. Other communication paths may also be used. The PPU advantageously implements a highly parallel processing architecture, and the PPU may be provided with any amount of local parallel processing memory (pp memory).

It will be appreciated that the system shown herein is illustrative and that variations and modifications are possible. The connection topology, including the number and arrangement of bridges or the number of parallel processing subsystems 312, may be modified as desired. For example, in some embodiments, system memory 144 could be connected to the processor(s) 142 directly rather than through memory bridge 305, and other devices may communicate with system memory 144 via memory bridge 305 and processor 142. In other embodiments, parallel processing subsystem 312 may be connected to I/O bridge 307 or directly to processor 142, rather than to memory bridge 305. In still other embodiments, I/O bridge 307 and memory bridge 305 may be integrated into a single chip instead of existing as one or more discrete devices. In certain embodiments, one or more components shown in FIG. 3 may not be present. For example, switch 316 could be eliminated, and network adapter 318 and add-in cards 320, 321 would connect directly to I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in at least one embodiment. For example, the parallel processing subsystem 312 may be implemented as a virtual graphics processing unit(s) (VPU(s)) that renders graphics on a virtual machine(s) (VM(s)) executing on a server machine(s) whose GPU(s) and other physical resources are shared across one or more VMs.

### Triplane Streaming Module

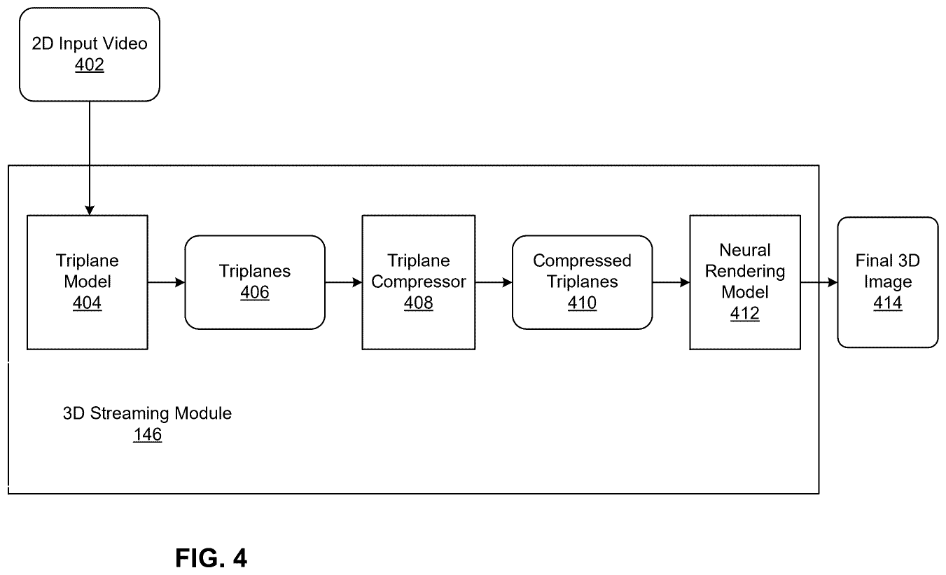

FIG. 4 is a more detailed illustration of the triplane streaming module 146 illustrated in FIG. 1, according to various embodiments. As shown, triplane streaming module 146 includes a triplane model 404, a triplane compressor 408, and a neural rendering model 412 that operate sequentially to generate final 3D Image 414 based on 2D input video 402.

According to some embodiments, 2D Input Video 402 is a stream of RGB (red-green-blue) images captured from a standard monocular camera. In some embodiments, 2D input video 402 may be the output of an external or built-in webcam connected to a computer or smartphone device. In operation, triplane model 404 accepts 2D input video 402 as input and generates triplanes 406 as output. Triplanes 406 are efficient representations of a 3D scene constructed from multiple planes of neural features. Triplane model 404 is a pre-trained model that generates triplane representations of three-dimensional scenes from two-dimensional images of those scenes. As described in greater detail below in conjunction with FIG. 9, in some embodiments, triplane model 404 is trained with a modified loss function that generates triplanes 406 that are robust to video compression.

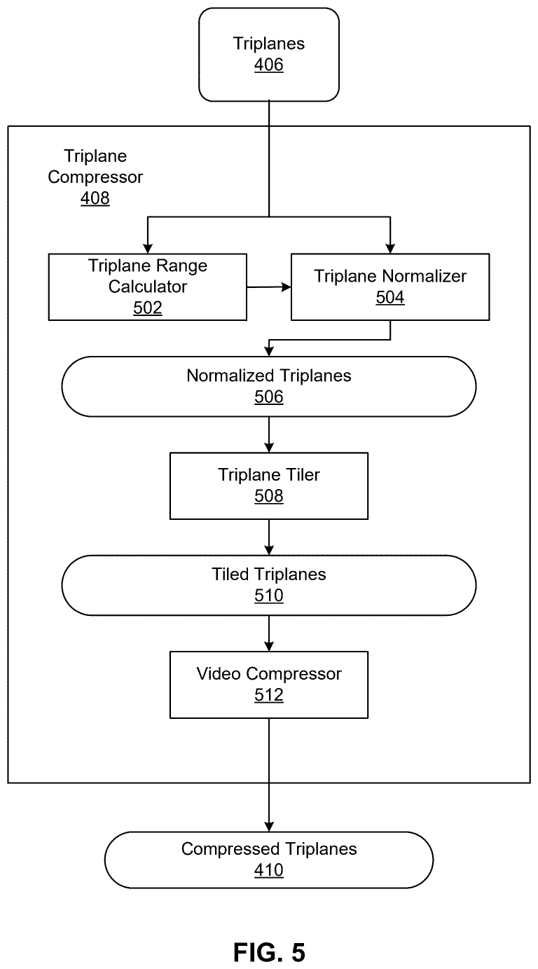

As shown in FIG. 4, triplane compressor 408 accepts triplanes 406 as input and generates compressed triplanes 410 as output. As described in greater detail below in conjunction with FIG. 5, to generate compressed triplanes 410, triplane compressor 408 normalizes the triplanes 406. Triplane compressor 408 then tiles those normalized triplanes 406 into a specified format, and passes the tiled triplanes 406 to a video compression codec. The video compression codec then compresses the tiled triplanes 406 and generates compressed triplanes 410.

Neural rendering model 412 accepts compressed triplanes 410 as input and generates final 3D image 414 as output. As described in greater detail below in conjunction with FIG. 5, neural rendering model 412 extracts the original triplanes from compressed triplanes 410, and performs neural rendering via ray tracing on the triplanes to generate final 3D image 414. In some embodiments, various optimizations are applied to enable fast neural rendering while maintaining video quality, including multi-pass sampling, temporal smoothing, and early stopping. It is noted that the foregoing examples are not meant to be limiting, and that any number, type, form, etc., of optimization(s) can be applied, at any level of granularity, consistent with the scope of this disclosure.

FIG. 5 is a more detailed illustration of triplane compressor 408 of FIG. 4, according to various embodiments. As shown, triplane compressor 408 includes triplane range calculator 502, triplane normalizer 504, triplane tiler 508, and video compressor 512 that operate as described below to generate compressed triplanes 410.

Upon being passed to triplane compressor 408, triplanes 406 are passed to triplane range calculator 502. Triplane range calculator 502 computes the range of each triplane 406 channel by identifying minimum and maximum values for each channel. The channel range values, along with triplanes 406, are passed to triplane normalizer 504. The channel range values are used to bias and scale the triplane 406 channels such that the channels map to a valid range for video encoding. The resulting triplanes after bias and scaling are normalized triplanes 506. The bias and scale values used to perform the normalization are attached to normalized triplanes 506 as metadata, so the original un-normalized triplanes can be recovered downstream.

Triplane tiler 508 accepts normalized triplanes 506 as input and generates tiled triplanes 510 as output. Triplane tiler 508 re-organizes normalized triplanes 506 into a format compatible with video compression algorithms. Specifically, all triplane values are stored in the luminance (Y) channel in a single video frame. The remaining chroma channels (UV) of the video frame are unused. The resulting tiled triplanes 510 include the same information as normalized triplanes 506, but are stored in a file format that can be compressed and transmitted like a standard video frame. In some embodiments, the tiling operation is efficiently performed using a kernel on a GPU.

Video compressor 512 accepts tiled triplanes 510 as input and generates compressed triplanes 410 as output. Video compressor 512 applies a standard video compression algorithm onto tiled triplanes 510, generating compressed triplanes 410. The video compression algorithm applied is chosen to be compatible with the destination visualization hardware. In some embodiments, the video compression is accelerated by efficient processing on the GPU or CPU.

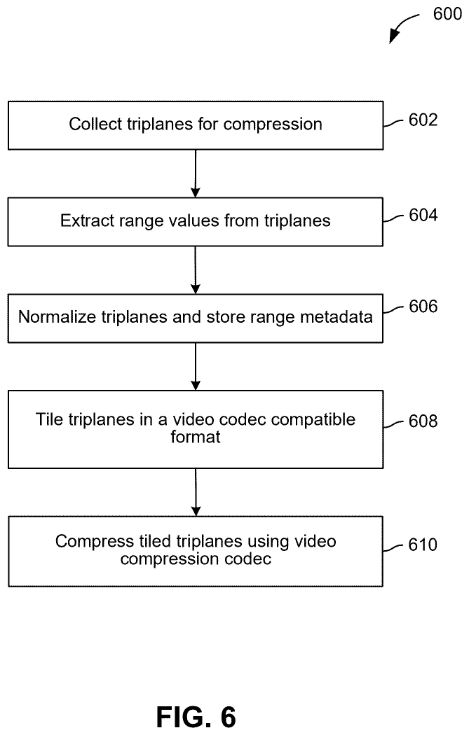

FIG. 6 sets forth a flow diagram of method steps for generating compressed tiled triplanes, according to various embodiments. Although the method steps are described in conjunction with the systems of FIGS. 1-5, persons skilled in the art will understand that any system configured to perform the method steps in any order falls within the scope of the present disclosure.

As shown, method 600 begins at step 602, where triplane compressor 408 receives triplanes 406 for processing to generate compressed triplanes 410. Triplanes 406 can be a set of triplanes representing any given three-dimensional scene. For example, in some embodiments triplanes 406 may represent the subject of a video webcam during a video conferencing session.

At step 604, triplane range calculator 502 accepts triplanes 406 and extracts minimum and maximum channel range values in each channel of the triplanes 406. Subsequently, at step 606, triplane normalizer 504 uses the minimum and maximum channel range values to compute normalized triplanes 506. Additionally, triplane normalizer 504 stores the channel range values as metadata along with normalized triplanes 506.

At step 608, triplane tiler 508 re-organizes the channels of normalized triplanes 506 to generate tile triplanes 510. Triplane tiler 508 stores the tile triplanes 510 in the luminance channel of a video frame, in a file format compatible with the selected video compression format.

At step 610, video compressor 512 compresses tiled triplanes 510 to generate compressed triplanes 410. Video compressor 512 applies a standard video compression to tiled triplanes 510 in a format compatible with the destination visualization hardware.

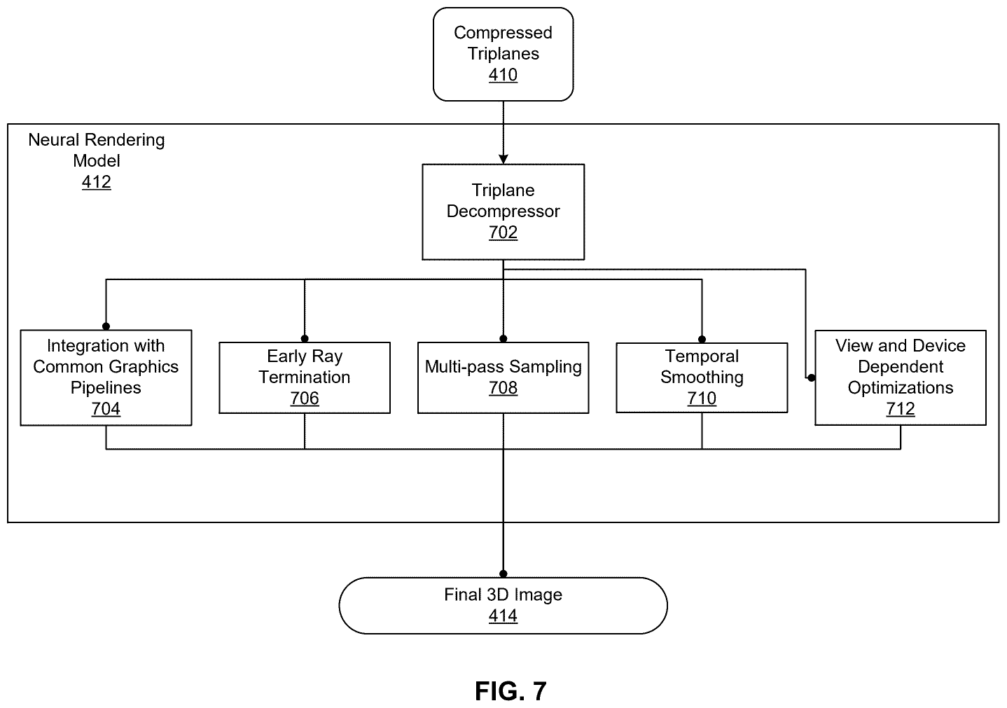

FIG. 7 is a more detailed illustration of neural rendering module 412, according to various embodiments. As shown, neural rendering model 412 consists of triplane decompressor 702, integration with common graphics pipelines 704, early ray termination 706, multi-pass sampling 708, temporal smoothing 710, and view and device dependent optimizations 712 that operate as described below to generate final 3D image 414 from compressed triplanes 410.

Upon being passed to neural rendering model 412, compressed triplanes 410 is passed to triplane decompressor 702. Triplane decompressor 702 performs an inverse procedure to that of triplane compressor 408, according to some embodiments. The output of triplane decompressor 702 are reconstructed triplanes to which range and mean values have been re-applied. After reconstruction, the full triplanes are used for neural rendering of final 3D image 414, with various efficiency modifications applied.

The output of triplane decompressor 702 is passed to various applications for neural rendering. In some embodiments, the applications, which can include efficiency modules, can be executed in parallel and in various orders. In some embodiments, not all of the applications illustrated in FIG. 7 are used in the rendering of final 3D image 414.

Integration with common graphics pipelines 704 loads the uncompressed triplanes into a graphics rasterization pipeline on specialized graphics rendering hardware, like a GPU. Neural rendering in the native graphics rasterization pipelines enables increased efficiencies in generating pixel values and querying the triplane object extremely quickly.

Early ray termination 706 modifies the standard neural rendering procedure to yield increased efficiencies available to video conferencing specific settings. Early ray termination 706 tracks the transparency value of the rendering object during ray projection during sampling. If the ray detects that opacity has changed substantially (meaning the edge of an object has been detected) the ray is terminated and no further samples are drawn. Early ray termination prevents the rendering of the back of the speakers head when the speaker is facing the camera, for example. By terminating non-visible rays early, early ray termination 706 completes neural rendering faster without loss of image quality.

Multi-pass sampling 708 modifies the standard neural rendering procedure to focus rendering computation on regions that require higher fidelity. Multi-pass sampling 708 uses importance sampling to identify regions of the 3D volume which contain high density objects. Multi-pass sampling is performed by sending a sparse, low resolution sample through the 3D volume. Then, the regions around sample points with high optical density are sampled at a higher resolution than those of lower density. The result of such a procedure is that, for video conferencing applications, regions containing the speaker are sampled at high resolution, while empty space around the speaker is sampled at low resolution, for example.

Temporal smoothing 710 modifies the standard neural rendering procedure to make rendering efficient by exploiting properties of video applications. Temporal smoothing 710 caches which regions of the 3D volume represented by the triplane contained opaque objects. Then, when the subsequent frame is being rendered, only pixels which contained opaque objects or were sufficiently near opaque objects need to be rendered, and empty cells can be ignored. Periodically, the cache can be re-computed from a full computation of ray marching to prevent degradation of quality.

View and device dependent optimizations 712 apply various optimizations that may be available depending on the hardware available on the rendering machine. For example, in some embodiments, a webcam is used to perform eye tracking to track the vision of the viewer watching the display. With the eye tracking information, rendering can be focused on regions at which the viewer is looking, and peripheral regions can be rendered at lower resolution. In some embodiments, the final 3D image is rendered on a holographic display, which renders a 3D image that is viewable from multiple angles. On such devices, views generally have to be rendered from many possible angles. However, in some embodiments, a webcam may be used to perform eye tracking on all viewers, and only render images for the perspective of the present viewers, thus saving many renderings from having to be performed.

After all neural rendering from the uncompressed triplane is performed, with some efficiency modules utilized according to some embodiments, neural rendering model 412 returns final 3D image 414.

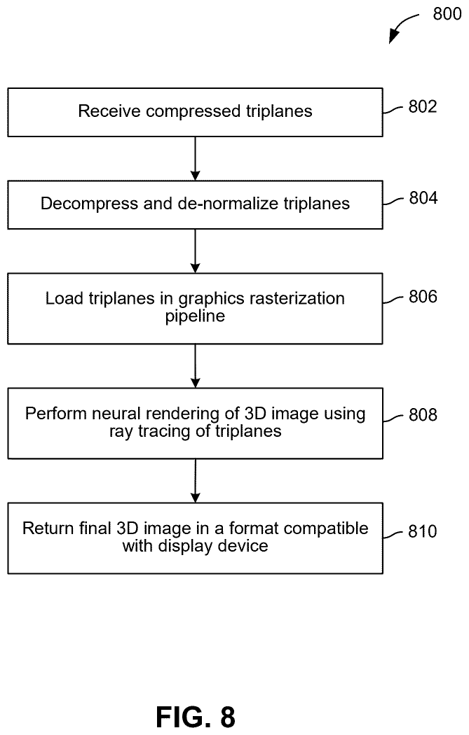

FIG. 8 sets forth a flow diagram of method steps for efficient neural rendering of 3D scenes from compressed triplanes, according to various embodiments. Although the method steps are described in conjunction with the systems of FIGS. 1-7, persons skilled in the art will understand that any system configured to perform the method steps in any order falls within the scope of the present disclosure.

As shown, method 800 begins at step 802, where neural rendering model 412 receives compressed triplanes 410 for processing to render final 3D image 414. In some embodiments, compressed triplanes 410 are the output of the process described in FIGS. 5 and 6.

At step 804, triplane decompressor 702 extracts the decompressed and de-normalized triplanes from compressed triplanes 410. In some embodiments, if compressed triplanes were generated using a process similar to that described in FIGS. 5 and 6, then triplane decompressor performs an inverse process to decompress and de-normalize the triplanes.

At step 806, integration with common graphics pipelines 704 loads the triplanes directly into graphics rasterization pipelines for more efficient neural rendering. In some embodiments, de-normalized triplanes are loaded into memory in some more general but less efficient manner rather than onto a graphics pipeline, and the process continues to step 808.

At step 808, neural rendering is performed using the de-normalized triplanes to generate final 3D image 414. Various efficient approximations may be applied during neural rendering step to improve the efficiency of neural rendering, in some embodiments. For example, in some embodiments, early ray termination 706 can be used to shorten rendering at the boundaries of visual objects. In some embodiments, multi-pass sampling 708 focuses neural ray tracing where primary objects are located in the rendered scene. In some embodiments, temporal smoothing 710 uses information from previous renders to concentrate ray tracing where primary objects are located in the rendered scene. Finally, in some embodiments, additional view and device dependent optimizations are applied to further enhance the efficiency of ray tracing, depending on the nature and capabilities of the final rendering device.

At step 810, the final 3D rendered image is returned to the final display device.

### Training of Triplane Streaming Application

FIG. 9 is a more detailed illustration of model trainer 116, according to some embodiments. As shown, model trainer 116 consists of triplane loss 904, total variation (TV) loss 906, and triplane compression loss 908, which operate to generate triplane model 404 from training images 902.

Model trainer 116 accepts training images 902 as input. Training images 902 are a collection of images of various 3D scenes captured from various angles. In some embodiments, training images 902 are captured from examples of a certain specialized application. For example, if the final triplane model 404 is going to be used primarily for rendering from webcam images from video conferencing, training images 902 may consist primarily of images captured from webcams from various angles. Training images 902 are passed to each of triplane loss 902, TV loss 906, and triplane compression loss 908.

Triplane loss 904 consists of the standard training procedure for triplane renderings of 3D scenes. Triplane loss 904 seeks to optimize the production of triplanes from images that accurately render 3D scenes from multiple viewing angles, trained against the references provided by training images 902.

TV Loss 906 extends triplane loss 904 to penalize both large triplane values as well as enforce a near-zero mean for all triplane values. The TV loss term ensures that triplanes are robust to normalization. TV loss 906 incentivizes robust normalization by adding terms to triplane loss 904 that penalize such properties during training.

Triplane compression loss 908 extends triplane loss 904 to incentivize the production of triplanes that are robust to video compression by explicitly compressing and de-compressing the triplanes during training and enforcing that quality is maintained comparable to the pre-compression triplane.

Triplane loss 904, TV Loss 906, and triplane compression loss 908 are aggregated, combined, etc., to generate a final loss function for model trainer 116. Model trainer 116 executes a training procedure that, upon achieving an associated convergence criteria, generates triplane model 404.

FIG. 10 sets forth a flow diagram of method steps for the training of triplane model 404, according to various embodiments. Although the method steps are described in conjunction with the systems of FIGS. 1-9, persons skilled in the art will understand that any system configured to perform the method steps in any order falls within the scope of the present disclosure.

As shown, method 1000 begins at step 1002, where model trainer 116 receives training images 902. Training images 902 is a collection of different 2D representations of multiple 3D scenes, and triplane model 404 is trained to represent the various 3D scenes and generate synthetic images from different perspectives of those scenes.

At step 1004, the standard triplane loss 904 is computed by generating synthetic scene images and by comparing synthetic scene triplanes to training triplanes. At step 1006, TV loss 906 computes the first additional loss term, the total variation (TV) loss, which seeks to minimize the dynamic range of the triplanes generated by model trainer 116. TV loss 906 is computed by calculating the mean and variance within each channel and computing a loss proportional to the deviation from zero mean and a small variance value. At step 1008, triplane compression loss 908 computes the second additional loss term, the triplane compression loss. Triplane compression loss 908 seeks to incentivize triplanes that compress and decompress efficiently without substantial numerical errors. Triplane compression loss 908 is computed by compressing and decompressing a triplane and adding loss terms for differences from the initial triplane introduced in this process.

At step 1010, the triplane loss 904, TV loss 906, and triplane compression loss 908 are aggregated, combined, etc., to compute the total loss. Then, backpropagation is computed using the total loss, and the weights of triplane model 404 are updated. At step 1012, the convergence criteria of the training algorithm is assessed. If the convergence criteria have been achieved, then the process continues to step 1014 and returns the final triplane model 404. If the convergence criteria have not been achieved, then the process returns to step 1004, and steps 1004-1012 iterate until the convergence criteria have been achieved.

In sum, the disclosed techniques are directed toward frameworks for implementing streamable and hardware accelerated neural 3D volumes for 3D video conferencing. More specifically, in various embodiments, a video stream from a monocular 2D video camera is captured. For each individual image of the scene, a triplane is generated using a triplane model. In some embodiments, the triplane model has been trained with a modified loss function. The modified loss function includes additional terms to encourage the generation of triplanes that compress more efficiently. The triplane is normalized, rearranged, and compressed into a standard video compression codec. That compressed video packet is sent over a web interface to a client. The client decompresses and reassembles the triplane and passes the triplane to a neural rendering model. The neural rendering model generates a 3D scene from the triplane. In some embodiments, various efficient algorithms and processes are used to ensure the rendered 3D scene is generated accurately with low latency. For example, in some embodiments, importance sampling is used to concentrate projected rays for rendering in regions near the head of a subject. In other embodiments, early stopping is used to stop rendering when an opacity threshold is reached and further cells would not be visible to the client, because the cells are on the back of the head of the subject, for example. Finally, the rendered 3D scene is sent to a compatible display and shown to the client user.

At least one technical advantage of the disclosed techniques relative to the prior art is that the disclosed techniques do not require specialized camera hardware or pre-video imaging to generate high-fidelity 3D images. As a result, the disclosed techniques can be used to implement video conferencing applications using existing hardware without additional implementation or equipment costs. An additional technical advantage of the disclosed techniques relative to the prior art is that the disclosed techniques provide for significantly reduced network and rendering overhead. In particular, by leveraging video compression tools, the disclosed techniques are capable of transmitting 3D video with sufficient speed to enable live video conferencing. Additionally, efficient improvements on the rendering side similarly enable live video conferencing with neural rendered 3D images.

1. In some embodiments, a computer-implemented method for generating compressed video content comprises: receiving a plurality of triplanes associated with video content; extracting channel range values from each triplane included in the plurality of triplanes; normalizing the plurality of triplanes based on the channel range values to generate a plurality of normalized triplanes; storing the channel range values with the plurality of normalized triplanes; generating a plurality of tiled triplanes based on the plurality of normalized triplanes; compressing the plurality of tiled triplanes to generate compressed video content; and transmitting the compressed video content to an endpoint device.

2. The computer-implemented method of clause 1, wherein each triplane included in the plurality of triplanes is generated based on neural features of the video content.

3. The computer-implemented method of clause 1, wherein the video content comprises two-dimensional (2D) video content that is generated by a digital video camera.

4. The computer-implemented method of clause 1, wherein the plurality of triplanes correspond to a human pictured in the video content.

5. The computer-implemented method of clause 1, wherein extracting the channel range values for a given triplane included in the plurality of triplanes comprises extracting a minimum channel range value and a maximum channel range value for each channel included in a plurality of channels of the triplane.

6. The computer-implemented method of clause 1, wherein the channel range values are stored as metadata associated with the plurality of normalized triplanes.

7. The computer-implemented method of clause 1, wherein generating the plurality of tiled triplanes based on the plurality of normalized triplanes comprises reorganizing channels of the plurality of normalized triplanes.

8. The computer-implemented method of clause 7, wherein reorganizing the channels of the plurality of normalized triplanes renders the plurality of tiled triplanes compatible with video compression algorithms.

9. The computer-implemented method of clause 7, wherein reorganizing the channels of the plurality of normalized triplanes comprises storing the plurality of tiled triplanes in a luminance channel of the video content.

10. The computer-implemented method of clause 9, wherein the plurality of tiled triplanes are stored in the luminance channel of a single video frame of the video content.

11. In some embodiments, one or more non-transitory computer-readable media store instructions that, when executed by one or more processors, cause the one or more processors to generate compressed video content, by performing the steps of: receiving a plurality of triplanes associated with video content; extracting channel range values from each triplane included in the plurality of triplanes; normalizing the plurality of triplanes based on the channel range values to generate a plurality of normalized triplanes; storing the channel range values with the plurality of normalized triplanes; generating a plurality of tiled triplanes based on the plurality of normalized triplanes; compressing the plurality of tiled triplanes to generate compressed video content; and transmitting the compressed video content to an endpoint device.

12. The one or more non-transitory computer-readable media of clause 11, wherein the compressed video content is generated via a video compression codec.

13. The one or more non-transitory computer-readable media of clause 12, wherein the video compression codec is based on at least one hardware component associated with the endpoint device.

14. The one or more non-transitory computer-readable media of clause 11, wherein transmitting the compressed video content to the endpoint device causes the endpoint device to generate decompressed video content based on the compressed video content and output the decompressed video content via at least one display device.

15. The one or more non-transitory computer-readable media of clause 11, wherein each triplane included in the plurality of triplanes is generated based on neural features of the video content.

16. The one or more non-transitory computer-readable media of clause 15, wherein the video content comprises two-dimensional (2D) video content that is generated by a digital video camera.

17. The one or more non-transitory computer-readable media of clause 11, wherein the plurality of triplanes correspond to a human pictured in the video content.

18. The one or more non-transitory computer-readable media of clause 11, wherein extracting the channel range values for a given triplane included in the plurality of triplanes comprises extracting a minimum channel range value and a maximum channel range value for each channel included in a plurality of channels of the triplane.

19. The one or more non-transitory computer-readable media of clause 11, wherein the channel range values are stored as metadata associated with the plurality of normalized triplanes.

20. In some embodiments, a computer system comprises one or more memories storing instructions, and one or more processors that are coupled to the one or more memories, and that, when executing the instructions, are configured to generate compressed video content, by performing the steps of: receiving a plurality of triplanes associated with video content; extracting channel range values from each triplane included in the plurality of triplanes; normalizing the plurality of triplanes based on the channel range values to generate a plurality of normalized triplanes; storing the channel range values with the plurality of normalized triplanes; generating a plurality of tiled triplanes based on the plurality of normalized triplanes; compressing the plurality of tiled triplanes to generate compressed video content; and transmitting the compressed video content to an endpoint device.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating compressed video content, the method comprising:
receiving a plurality of triplanes associated with video content;
extracting channel range values from each triplane included in the plurality of triplanes;
normalizing the plurality of triplanes based on the channel range values to generate a plurality of normalized triplanes;
storing the channel range values with the plurality of normalized triplanes;
generating a plurality of tiled triplanes based on the plurality of normalized triplanes;
compressing the plurality of tiled triplanes to generate compressed video content; and
transmitting the compressed video content to an endpoint device.

2. The computer-implemented method of claim 1, wherein each triplane included in the plurality of triplanes is generated based on neural features of the video content.

3. The computer-implemented method of claim 1, wherein the video content comprises two-dimensional (2D) video content that is generated by a digital video camera.

4. The computer-implemented method of claim 1, wherein the plurality of triplanes correspond to a human pictured in the video content.

5. The computer-implemented method of claim 1, wherein extracting the channel range values for a given triplane included in the plurality of triplanes comprises extracting a minimum channel range value and a maximum channel range value for each channel included in a plurality of channels of the triplane.

6. The computer-implemented method of claim 1, wherein the channel range values are stored as metadata associated with the plurality of normalized triplanes.

7. The computer-implemented method of claim 1, wherein generating the plurality of tiled triplanes based on the plurality of normalized triplanes comprises reorganizing channels of the plurality of normalized triplanes.

8. The computer-implemented method of claim 7, wherein reorganizing the channels of the plurality of normalized triplanes renders the plurality of tiled triplanes compatible with video compression algorithms.

9. The computer-implemented method of claim 7, wherein reorganizing the channels of the plurality of normalized triplanes comprises storing the plurality of tiled triplanes in a luminance channel of the video content.

10. The computer-implemented method of claim 9, wherein the plurality of tiled triplanes are stored in the luminance channel of a single video frame of the video content.

11. One or more non-transitory computer-readable media storing instructions that, when executed by one or more processors, cause the one or more processors to generate compressed video content, by performing the steps of:
receiving a plurality of triplanes associated with video content;
extracting channel range values from each triplane included in the plurality of triplanes;
normalizing the plurality of triplanes based on the channel range values to generate a plurality of normalized triplanes;
storing the channel range values with the plurality of normalized triplanes;
generating a plurality of tiled triplanes based on the plurality of normalized triplanes;
compressing the plurality of tiled triplanes to generate compressed video content; and
transmitting the compressed video content to an endpoint device.

12. The one or more non-transitory computer-readable media of claim 11, wherein the compressed video content is generated via a video compression codec.

13. The one or more non-transitory computer-readable media of claim 12, wherein the video compression codec is based on at least one hardware component associated with the endpoint device.

14. The one or more non-transitory computer-readable media of claim 11, wherein transmitting the compressed video content to the endpoint device causes the endpoint device to generate decompressed video content based on the compressed video content and output the decompressed video content via at least one display device.

15. The one or more non-transitory computer-readable media of claim 11, wherein each triplane included in the plurality of triplanes is generated based on neural features of the video content.

16. The one or more non-transitory computer-readable media of claim 15, wherein the video content comprises two-dimensional (2D) video content that is generated by a digital video camera.

17. The one or more non-transitory computer-readable media of claim 11, wherein the plurality of triplanes correspond to a human pictured in the video content.

18. The one or more non-transitory computer-readable media of claim 11, wherein extracting the channel range values for a given triplane included in the plurality of triplanes comprises extracting a minimum channel range value and a maximum channel range value for each channel included in a plurality of channels of the triplane.

19. The one or more non-transitory computer-readable media of claim 11, wherein the channel range values are stored as metadata associated with the plurality of normalized triplanes.

20. A computer system, comprising:
one or more memories storing instructions; and
one or more processors that are coupled to the one or more memories and, when executing the instructions, are configured to generate compressed video content, by performing the steps of:
receiving a plurality of triplanes associated with video content;
extracting channel range values from each triplane included in the plurality of triplanes;
normalizing the plurality of triplanes based on the channel range values to generate a plurality of normalized triplanes;
storing the channel range values with the plurality of normalized triplanes;
generating a plurality of tiled triplanes based on the plurality of normalized triplanes;
compressing the plurality of tiled triplanes to generate compressed video content; and
transmitting the compressed video content to an endpoint device.
